(19) United States
(12) Patent Application Publication
(10) Pub. No.: US 2009/0318293 A1
(43) Pub. Date: Dec. 24, 2009

(54) AGRICULTURAL COMPOSITION

(75) Inventor: David Marks, Witherslack (GB)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: PLANT IMPACT PLC, MANCHESTER (GB)

(21) Appl. No.: 12/091,165

(22) PCT Filed: Oct. 24, 2006
(86) PCT No.: PCT/GB2006/003952

§ 371 Date: Aug. 6, 2008

(30) Foreign Application Priority Data
Oct. 28, 2005 (GB) 0521993.6
Oct. 11, 2006 (GB) 0620078.6

(51) Int. Cl. A01N 43/90; A01P 21/00

(52) U.S. Cl. 504/136; 504/241

(57) ABSTRACT

The use of a member of the caffeine family as a plant reproductive growth stimulator, and in the promotion of maturity in plants. In particular the use of a member of the caffeine family in promoting flowering, colouration or fruiting in plants. Also agricultural compositions comprising a member of the caffeine family present at a concentration in the range of 50 to 500 ppm and agricultural compositions which comprise (i) a member of the caffeine family and (ii) a plant nutrient or a compound of formula (I) wherein R¹ is a C₁₋₁₀ alkyl group, or a C₂₋₁₀alkenyl group and M is a cation of valency n. Also formulations containing the compositions and methods of their uses are included.

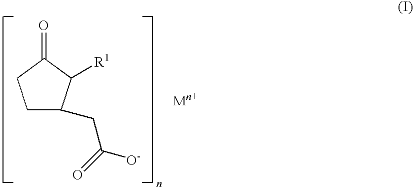

The present invention relates to the new use of a known compound, to novel agricultural compositions containing that compound, to methods of preparing the compositions and to methods of their use, in particular in the treatment of plants.

The naturally occurring compound caffeine is well known and has many uses. It is a purine alkaloid. Purine is 7H-Imidazo[4,5-d]pyrimidine and the caffeine family are optionally alkyl substituted dione derivatives thereof.

In plant cultivation caffeine is known to be of use as a fungicide. It is also known to have an effect on the rate of DNA repair in plants. Also, in one study (Biologia Plantarum, (1998) vol. 40, No. 3, pp 329-335), caffeine was shown to be able to produce a weak cytokinin-like effect on cotyledon growth, chlorophyll biosynthesis and cell elongation in the systems studied.

It has now been found that caffeine can have non-cytokinin effects on plant growth and that caffeine and other related members of the purine alkaloid family have a use as plant growth stimulators.

According to the present invention there is provided the use in plant growth of a member of the caffeine family as a plant reproductive growth stimulator.

There is more particularly provided the use in plant growth of a member of the caffeine family to promote maturity in plants.

More particularly there is provided the use in plant growth of a member of the caffeine family in promoting flowering of plants; in promoting colouration in plants; and in promoting fruiting in plants.

The use of a caffeine family member according to the present invention involves the application of the caffeine family member to a growing plant and preferably to a crop producing plant.

It has been found that when a member of the caffeine family is used according to the present invention as a reproductive plant stimulator in the treatment of plants enhanced growth can be achieved. In particular earlier and greater maturity can be achieved. In flowering plants flowering can be promoted with earlier and/or increased flowering being observed. In fruiting plants quicker fruit development can be achieved. Further in fruiting plants an earlier increase in the sugar content of the fruit is observed as well as higher fruit sugar levels achieved. Also plant colouration can be enhanced, particularly where carotinoids are present, such that there is an enhancement in and acceleration of colouration, in particular with red, yellow and orange pigmentations. The use of a caffeine family member is also advantageous as less nutrient is lost to groundwater, heavy metals are not freed up with its use unlike with the use of chelates such as EDTA and it also allows the associated use of pest control measures.

The term “caffeine family” as used herein refers to optionally alkyl substituted dione derivatives of purine (7H-Imidazo[4,5-d]pyrimidine). Preferably the derivative is a 2,6 dione derivative of purine. The purine derivative may be unsubstituted or mono-, di- or tri-substituted. The alkyl substitutions are preferably at one or more of the 1, 3, or 7 positions on the purine base molecule. The alkyl substitutions may be any C₁₋₄ alkyl, such as methyl, ethyl or propyl with methyl being preferred.

Preferred members of the caffeine family for use in the present invention include caffeine (3,7-Dihydro-1,3,7-trimethyl-1H-purine-2,6-dione), xanthine (3,7-Dihydro-1H-purine-2,6-dione), theobromine (3,7-Dihydro-3,7-dimethyl-1H-purine-2,6-dione) and theophylline(3,7-Dihydro-1,3-dimethyl-1H-purine-2,6-dione). The most preferred member is caffeine.

One or member of the caffeine family may be used in accordance with the present invention.

When used according to the present invention the member of the caffeine family may be applied to the plants to be treated by any suitable means and in any suitable form. The caffeine family member may be used alone or used as a part of an agricultural composition.

According to the present invention there is further provided an agricultural composition for use as a plant reproductive growth stimulator, which composition comprises a member of the caffeine family, wherein the caffeine family member is present at a concentration in the range of 50 to 500 ppm.

The caffeine family member may, for example, be applied in solid or liquid form. A solid or liquid medium in which the caffeine family member can be delivered may be used. The caffeine family member may be applied in powder formulations. The caffeine family member may be bound to an inert or nutrient agent to assist in its incorporation into powder or dry formulations. For powder formulations a binding agent may be present to facilitate the incorporation into the powder formulation of the small doses of the caffeine family member that are required. Suitable binding agents include inert or nutrient powders such a magnesium sulphate, silica and the like. The caffeine is preferably applied in a liquid form, with the caffeine being dissolved or dispersed in a liquid medium. Any suitable medium may be used with water being preferred.

The caffeine family member may be present as a pure compound or in the form of a plant extract. Suitable plant extracts are those having a high level of caffeine and include tea and coffee plant extracts. Where necessary soluble preparations of plant extracts may be used. The caffeine family member may be present in the form of a salt thereof, with water-soluble salts being preferred.

The caffeine family member when present in an agricultural composition may be present at any level suitable to achieve the desired result. The caffeine family member is present at a concentration in the range of 50 to 500 ppm, more preferably in the range 100 to 300 ppm and most preferably around 150 to 250 ppm, e.g. at approximately 200 ppm.

The caffeine family member may be used in the treatment of plants as the sole active ingredient or in association with any other suitable active ingredient. The caffeine family member may be used simultaneously with or prior to or subsequent to the use of any other ingredient. The caffeine family member may be used separately or in admixture with any other active ingredient. The caffeine family member may, for example, be used in association with conventional agricultural compositions and formulations to enhance their performance. The caffeine family member may be used with, amongst others, a new or existing fertilizer, pesticide or growth stimulating composition or formulation.

It has been found advantageous for the caffeine family member to be used in association with one or more other agent able to promote plant growth. Suitable additional agents include certain plant health or growth promoters and/or plant nutrients.

According to the present invention there is further provided the use in plant growth of a member of the caffeine family as a plant reproductive growth stimulator in association with a water soluble salt of formula (I)

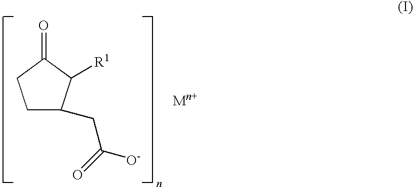

wherein R¹ is a C₁₋₁₀alkyl group, or a C₂₋₁₀alkenyl group and M is a cation of valency n.

According to the present invention there is further provided an agricultural composition comprising: (i) a member of the caffeine family and (ii) a water soluble salt of a compound of formula (I) as defined above.

According to the present invention there is further provided the use in plant growth of a member of the caffeine family as a plant reproductive growth stimulator in association with a plant nutrient.

According to the present invention there is further provided an agricultural composition comprising: (i) a member of the caffeine family and (ii) a plant nutrient, wherein the caffeine family member is present at a concentration in the range of 50 to 500 ppm.

Plants need a range of nutrients for healthy growth. These include macronutrients, secondary nutrients and micronutrients. The compositions of the present invention may comprise one or more of each of these types of plant nutrients as well as mixtures thereof.

Suitable macronutrients for use in the compositions of the present invention include nitrogen, phosphorus, potassium, carbon and water. Suitable secondary nutrients include calcium, magnesium, sodium, chloride and sulphur. Suitable micronutrients include copper, cobalt, iron, manganese, boron, molybdenum, zinc, silicon and nickel.

It is preferred that where possible the plant nutrient is present in the form of a water-soluble salt. Suitable water-soluble salts include nitrates, sulphates and chlorides, with nitrates and chlorides being preferred. Specific examples include zinc nitrate, iron sulphate, zinc sulphate, magnesium sulphate, manganese sulphate, iron nitrate or manganese nitrate.

The plant nutrient salt will be present in an amount suitable to the nature of the plant nutrient. Individual macronutrients may be present in the composition in an amount of from 5% to 20% w/w, preferably from 7 to 15% w/w and most preferably from 9 to 15% w/w. Individual secondary nutrients may be present in the composition in an amount of from 5% to 15% w/w, preferably from 5 to 10% w/w and most preferably from 7 to 9% w/w. Individual micronutrients may be present in the composition in an amount of from 0.001% to 1% w/w, preferably from 0.005 to 0.9% w/w and most preferably from 0.005 to 0.6% w/w.

The caffeine family member is present in the composition at a concentration in the range of 50 to 500 ppm, preferably in the range 100 to 300 ppm and more preferably around 150 to 250 ppm, e.g. at approximately 200 ppm. The caffeine family member is present in the composition at a concentration in the range of 0.005 to 0.050% w/w of the total composition, preferably in the range of 0.01 to 0.03% w/w and more preferably about 0.015 to 0.025% w/w, e.g. at approximately 0.020% w/w.

Where the use of the caffeine family member is in association with a water soluble salt of formula (I), the cation M may be a metal cation, such as a cation of an alkali metal, in particular potassium or sodium (where n is 1) or an alkaline earth metal such as magnesium where n is 2, provided that the salt formed therefrom is water soluble. Therefore M is suitably other than calcium. The salt may be in the form of a water miscible oil (such as the potassium and sodium salts) or it may be in the form of a solid, such as the magnesium salt.

Alkyl or alkenyl groups R¹ may be straight or branched. Preferably however, R¹ is a straight chain alkyl or alkenyl group.

In a particular embodiment R¹ contains 5 carbon atoms. It is preferably selected from a pentyl group, making the compound of formula (I) a dihydrojasmonate salt, or it is a pent-2-enyl group, so that the compound of formula (I) is a jasmonate salt.

Suitably, the compound of formula (I) is a water-soluble salt of a derivative of dihydrojasmonic acid. A particularly preferred salt therefore is magnesium dihydrojasmonate. This salt has very good handling and flow properties, making it particularly useful in the context of agrochemical formulations.

In one embodiment of the present invention in the compound of formula (I) M is as described above provided that when R¹ is a pent-2-enyl group, M is other than sodium or potassium.

The salt of the compound of formula (I) may be present in the concentration range of 0.001% to 1.000% w/w, preferably in the concentration range of 0.003% to 0.500% w/w, more preferably in the concentration range of 0.003% to 0.100% w/w and most preferably in the concentration range of 0.005% to 0.050% w/w.

Compounds of formula (I) may be prepared using a method comprising reacting a compound of formula (II)

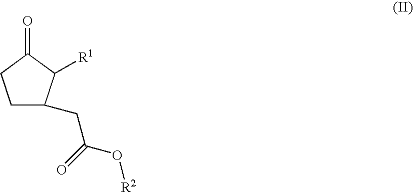

where R¹ is as defined in relation to formula (I) and R² is selected from hydrogen or a hydrocarbyl group, with a compound of formula (III)

Mⁿ⁺(OR³)ₙ (III)

where M and n are as defined in relation to formula (I), and R³ is hydrogen or a C₁₋₃alkyl group such as methyl. The reaction is suitably effected in a solvent, which may be water, or an organic solvent such as an alkanol, in particular methanol or toluene.

Depending upon the particular salt being prepared, the reaction may be effected at moderate temperatures, for example from 0 to 50° C., conveniently at room temperature, or it may be conducted at elevated temperatures, for example from 50° C. to 100° C., and conveniently at the reflux temperature of the solvent.

The product is suitably recovered either as a solid following evaporation of solvent, or it may be in the form of an aqueous solution, which is used directly in formulations.

As used herein, the term “hydrocarbyl” refers to organic moieties comprising carbon and hydrogen, such as alkyl, alkenyl, alkynyl, aryl or aralkyl groups such as benzyl. The term “alkyl” refers to straight or branched chains which suitably contain from 1 to 20, and preferably from 1 to 10 carbon atoms. Similarly the terms “alkenyl” and “alkynyl” refer to unsaturated hydrocarbyl groups, suitably containing from 2 to 20 and preferably from 2 to 10 carbon atoms. The term “aryl” refers to aromatic hydrocarbyl groups such as phenyl and naphthyl, whereas the term “aralkyl” refers to alkyl groups that are substituted with aryl groups such as benzyl. In a particular embodiment, where R² is a hydrocarbyl group, it is selected from a C₁₋₁₀alkyl group, and suitably a C₁₋₆alkyl group such as methyl.

The compounds of formula (III) are known compounds such as potassium hydroxide, which may be used directly. Alternatively, the compound of formula (III) may be generated in situ. This may be particularly applicable where M is a magnesium salt, and where R³ is a C₁₋₃alkyl group such as methyl. The applicants have found that a good way of preparing this compound is to react magnesium with an C₁₋₃alkanol such as methanol in the presence of a catalyst such as iodine. The reaction mixture is suitably heated to form the compound of formula (III) whereupon, a solution of the compound of formula (II) in the same alkanol is added and the reaction initiated.

The compounds of formula (II) are either known compounds or they may be prepared using conventional methods. Suitable reaction conditions will be apparent to a skilled chemist, but may include reacting the compound of formula (II) where R² is a hydrocarbyl group with a base such as sodium hydroxide, and then with an acid such as hydrochloric acid.

Compounds of formula (I) may include a chiral centre, and the invention includes all forms, including optically active forms, and mixtures thereof in all proportions including racemic mixtures.

The caffeine family member is preferably present in the composition at a concentration in the range of 50 to 500 ppm, more preferably in the range 100 to 300 ppm and most preferably around 150 to 250 ppm, e.g. at approximately 200 ppm. The caffeine family member is preferably present in the composition at a concentration in the range of 0.005 to 0.050% w/w of the total composition, more preferably in the range of 0.01 to 0.03% w/w and most preferably about 0.015 to 0.025% w/w, e.g. at approximately 0.020% w/w.

The compositions may be applied as a solid powder. They may, for example, be in the form of particles or granules. Alternatively the compositions may be applied in liquid form.

The compositions of the present invention may also comprise one or more other agriculturally acceptable component. Examples of such components include water, nutrient material, plant health or growth promoters, plant oils, metabolic stimulating agents, emulsifiers, thickeners, suspension agents, dispersion agents, carriers or excipients, solubility agents, wetting agents, binding agents and essential oils.

Suitable nutrient material includes the plant nutrients described above and additional nutritional products and plant health or growth promoters (or stimulants) include those conventionally used in crop nutrition, such as seaweed extract powders, humic and fulvic acid powders, amino acid powders and a water soluble salt of formula (I) as defined above.

Suitable plant oils for inclusion in the compositions of the present invention include canola oil (oilseed rape oil), soybean oil, cottonseed, castor oil, linseed oil and palm oil.

Suitable emulsifiers for use in the compositions of the present invention include any known agriculturally acceptable emulsifier. In particular, the emulsifier may comprise a surfactant such as: typically alkylaryl sulphonates, ethoxylated alcohols, polyalkoxylated butyl ethers, calcium alkyl benzene sulphonates, polyalkylene glycol ethers and butyl polyalkylene oxide block copolymers as are known in the art. Nonyl phenol emulsifiers such as Triton N57™ are particular examples of emulsifiers, which may be used in the compositions of the invention, as are polyoxyethylene sorbitan esters such as polyoxyethylene sorbitan monolaurate (sold by ICI under the trade name “Tween™”). In some instances, natural organic emulsifiers may be preferred, particularly for organic farming applications. Coconut oils such as coconut diethanolamide is an example of such an compound. Palm oil products such as lauryl stearate may also be used.

Examples of thickeners which may be present in the compositions of the present invention comprise gums, for example xanthan gum, or lignosulphonate complexes, as are known in the art.

Suitable suspension agents that may be included in the compositions of the present invention include hydrophilic colloids (such as polysaccharides, polyvinylpyrrolidone or sodium carboxymethylcellulose) and swelling clays (such as bentonite or attapulgite).

Suitable solubility agents that may be included in the compositions of the present invention include, for example, any that enhance the solubility of a member of the caffeine family in a solvent. The solubility of caffeine in water, for example, is increased by alkali benzoates, cinnamates, citrates and salicylates.

Suitable wetting agents for use in the compositions of the present invention include surfactants of the cationic, anionic, amphoteric or non-ionic type, as is known in the art.

For powder formulations a binding agent may be present to facilitate the incorporation into the powder formulation of the small doses of the caffeine family member that are required. Suitable binding agents include inert or nutrient powders such a magnesium sulphate, silica and the like.

The compositions of the present invention may further comprise one or more essential oil or active components thereof. The compositions may suitably contain no more than 5% w/w of essential oil, more suitably no more than 3% w/w and preferably no more than 1.5% w/w of essential oil. For instance, the composition may contain no more than 1% w/w essential oil.

As used herein, the expression “essential oil” refers to natural aromatic oils, obtainable from plants. Particular essential oils include tagetes oil, such as the oil obtainable Tagetes erecta and thyme oil, such as the oil obtainable from Thymus vulgaris, Wintergreen oil, Rosemary oil, garlic oil, oils from Chenopodium, Erythroxylum, Eugenia, Gaultheria, Myristica, Syzygium, Xanthophyllum, Cinnamonium, Gualtheria, Gossypium and mentha. However, essential oils for inclusion in the compositions of the invention are obtainable from in a wide range of plant families including those families listed in the following Table 1. The Table also includes examples of particular species found within each of these families

TABLE 1

Family
Acanthaceae

Adhatoda vasica (malabar nut)

Anacardiaceae

Anacardum occidentale (cashew nut)

Annonaceae

Annona reticulata (bullocks heart)
Annona squamosa (custard apple)
Monodora myristica (nutmeg)

Apiacea (umbelliferae)

Anethum graveolens (dill)
carum carvi (caraway)
Carum roxburghianum (Bishops weed)
Pimpinella anisum (aniseed)

Apocynaceae

Nerium oleander (oleander)

Araceae

Acorus calamus (flagroot)

Asteraceae

Ageratum conzyaides (goatweed)
Artemesia vulgaris (mugwort)
Bulmea balsamifera (camphor)
Chrysanthemum indicum (manzanilla)
Sausurea lappa
Hellianthus annus (sunflower)

Brassicaceae

Raphanus sativus (radish)

Ceasalpinaceae

Erythrophleum suaveolens (ordeal tree)

Cappardaceae

Bosica senegalensis
Cleome monophylla

Cellastraceae

Celastrus angulatus (Chinese bittersweet)

Chenopodiacea

Chenopodium ambrosiodes (Sweet pigweed)

Clusiaceae

Calophyllum inophyllgum (luarelwood)

Convulvulaceae

Convulvulus arvensis (field bindweed)

Cucurbitaceae

Momordica charantia (Balsam pear)

Dipterocarpaceae

Shorea robusta (sal tree)

Ericaeae

Gualtheria procumbens (wintergreen)

Euphorbiaceae

Jatropha curcus (Physic nut)

Fabaceae

Butea frondosa (flame of the forest)
Gliricidia sepium (Madre de Cacao)
Psoralea coylifolia
Pongamia glabra (karanja)
Trigonella foenum (fenugreek)

Graminaceae

Cymbopgon martini (gingergrass)
Oryza sativa (rice)

Laminaeae

Bystropogon spp.
Coleus amboinicus (oregano)
Hyptis spicigera (black sesame)
Hyptis suaveolens
Lavendula angustifolia (lavender)
Mentha arvensis (cornmint)
Mentha longifolia (Horsemint)
Mentha piperita (peppermint)
Mentha spicata (spearmint)
Osimum basilicum (sweet basil)
Osimum canum (American basil)
Osimum kilimandscharicum
Osimum suave (wild basil)
Origanum vulgarae (oregano)
Pogostemon heyneanus
Rosmarianus officianis (rosemary)
Salvia officianalis (sage)
Thymus vulgaris (garden thyme)
Tetradenia riparia

Lauraceae

Cinnamomum aromaticum (cassia)
Luaris nobilis (sweet bay)

Liliaceae

Allium
Allium sativum (garlic)

Meliaceae

Azadirachta indica (neem)
Melia azedarach (Persian lilac)

Menisperaceae

Cissampelos owariensis (Pareira brava)

Myrsinaceae

Embelia ribes

Myrtaceae

Eucalyptus spp.
Eucalyptus citriodara (lemon-scented gum)
Eucalyptus globus (Blue gum tree)
Eucalyptus terreticomis
Psidium guajava (guava)
Syzygium aromaticum (clove)

Myristicaceae

Myristica fragrans (mace)

Piperaceae

Piper cubeda (java long pepper)
Piper guineense (Ashanti pepper)
Piper nigrum (black pepper)

Ranunculaceae

Nigella sativa (black cumin)

Rutaceae

Aegle marmelos (Bengal quince)
Citrus aurantifolia (lime)
Citrus limon (lemon)
Citrus paradisi (grapefruit)
Citrus sinensis (sweet orange)
Limonia acidissima (roem)
Zanthoxylum alatum (prickly ash)

Simarubaceae

Quassia Africana

Solanaceae

Capsicum annum (bell pepper)
Capsicum frutescens (Tabasco)
Lycopersicon esculentum (tomato)
Nicotiana tabacum (tobacco)
Withania somnifera (winter cherry)

Vebenaceae

Clerodendron siphonanthus
Lanatana camara (yellow sage)
Lippia geminata (wild sage)
Vitex negundo (begunnia)

Zingiberaceae

Afromomum melagueta (grains of pleasure)
Alpinia galanga (greater galangal)
Curcuma longa (tumeric)
Zingiber officinale (ginger)

The term “active components thereof” refers to the chemicals within the essential oil that give rise to the desired activity in plants. Such activities include metabolic stimulating effects, antimicrobial effects, insect or arachnid killing or repellent effects, antiviral and viral remediation effects. The oils may be present alone or combinations of different oils may be included.

The caffeine family member and agricultural compositions of the present invention may be applied to plants, in particular crop plants, in any conventional manner, e.g. by soil or foliar application. They may be applied to root systems, stems, seeds, grains, tubers, flowers, fruit, etc. as required. Examples of means of application include spraying, e.g. by means of an electrostatic or other conventional sprayer, or drip irrigation methods or fertigation systems, which involve application directly to the soil.

The caffeine family member and compositions of the present invention may be adapted for the means of application, e.g. prepared in a form suited to the required means of application. They may take the form of liquid or solid concentrates, which require dilution before application. They may be formed into, for example, water dispersible granules, slow or fast release granules, soluble concentrates, oil miscible liquids, ultra low volume liquids, emulsifiable concentrates, dispersible concentrates, oil in water, and water in oil emulsions, micro-emulsions, suspension concentrates, aerosols, capsule suspensions and seed treatment formulations. Aerosol versions of the compositions may be prepared using a suitable propellant, for example n-butane. The form type chosen in any instance will depend upon the particular purpose envisaged and the physical, chemical and biological properties of the composition.

The caffeine family member and compositions of the present invention may be prepared using any conventional techniques and methods. Granules may be, for example, formed either by granulating a composition alone or with one or more powdered solid diluents or carriers. Dispersible concentrates may be prepared by mixing the caffeine family member or a composition of the present invention in water or an organic solvent, such as a ketone, alcohol or glycol ether. Suspension concentrates may be prepared by combining the compositions in a suitable medium, optionally with one or more dispersing agents, to produce a suspension. One or more wetting agents may be included in the suspension and a suspending agent maybe included to reduce the rate of settling.

According to a yet further aspect of the present invention there is provided a formulation for administration to plants or to the environment of plants, the formulation comprising a composition according to the present invention and a medium in which the composition may be dispersed or dissolved.

Suitable mediums may be solid or liquid dependent upon the nature of the formulation and include any known dispersants or solvents for the composition, for example water or a water miscible liquid, such as n-propanol. The medium is preferably such as to provide formulations that may be used in non-pressurised, hand-actuated spray pumps. The medium is preferably a solvent and most preferably water.

Solid mediums or diluents may include natural clays, kaolin, pyrophyllite, bentonite, alumina, montmorillonite, kieselguhr, chalk, diatomaceous earths, calcium phosphates, pumice, attapulgite clays, fuller's earth, ground corn cobs, sands, silicates, sodium, calcium or magnesium carbonates, sodium bicarbonate, magnesium sulphate, lime, flours, talc, polysaccharides and other organic and inorganic solid carriers.

Liquid mediums or diluents may include water or organic solvents such as a ketone, alcohol or glycol ether. These solutions may contain a surface-active agent (for example to improve water dilution or prevent crystallisation in a spray tank).

The amount of dispersant or solvent, e.g. water, used will depend upon the particular mode of administration of the formulation and to where it is being applied. In general, a formulation according to the present invention may contain from 10-20% v/v of the composition of the present invention with the remainder being dispersant or solvent, e.g. water.

Formulations according to the present invention may be prepared by admixing a caffeine family member with currently available agricultural compositions, for example, with existing fertilisers. Although the amount of caffeine family member required for achieving the required effect is relatively low, (e.g. around 200 ppm), difficulties have arisen in incorporating the caffeine family member into known liquid fertiliser products. This has been found to be a particular problem with the addition of caffeine to liquid fertilisers that have large amounts of plant nutrients, i.e. those with high element analysis, after the fertiliser product has been manufactured. This may be due to the product being saturated with element salts leaving little solvent left to allow the caffeine to be incorporated into the solution. There has now been found a method of overcoming these difficulties and of allowing the successful preparation of high nutrient content caffeine containing liquid compositions.

According to the present invention there is yet further provided a method for the preparation of a liquid agricultural formulation comprising a member of the caffeine family, one or more plant nutrient and a solvent, which method comprises admixing the caffeine family member and solvent prior to the addition of the one or more plant nutrient.

The present invention is suitable for use on growing plants, particularly crop producing plants. It has been found to be of particular use in the treatment of greenhouse crops, vegetables, and fruit crops, such as tomatoes, strawberries and peppers.

The amount of composition or formulation applied in any particular situation will vary depending upon a number of factors such as the nature of the crop. Typically, where the composition or formulation is in the form of a solution the amount of solution applied is sufficient to provide a solution concentration sprayed to runoff-rate of between 2 ml/lt and 20 ml/lt. In a particular embodiment, the invention provides the use of a composition or formulation according to the present invention as a fertilizer, for administration to crops at a rate of from 1 to 30 litres per hectare, and preferably from 1 to 10 litres per hectare.

The compositions and formulations may be used either alone (and in this case, they may be suitable for organic growers) or in conjunction with other agrochemicals such as fungicides, insecticides or acaricides.

According to another aspect of the present invention there is provided a method for stimulating reproductive growth in plants, which method comprises applying a member of the caffeine family to the plants or to the environment thereof.

According to another aspect of the present invention there is provided a method for promoting maturity in plants, which method comprises applying a member of the caffeine family to the plants or to the environment thereof.

According to another aspect of the present invention there is provided a method of increasing flowering or for accelerating the onset of flowering in plants, which method comprises applying a member of the caffeine family to the plants or to the environment thereof.

According to another aspect of the present invention there is provided a method for improving or accelerating the onset of colouration in plants, which method comprises applying a member of the caffeine family to the plants or to the environment thereof.

According to another aspect of the present invention there is provided a method for improving or accelerating the onset of fruiting in plants, which method comprises applying a member of the caffeine family to the plants or to the environment thereof.

For all of the above methods according to the present invention in addition to the application of a member of the caffeine family the method may also comprise applying to the plants or to the environment thereof, simultaneously or successively in either order a plant nutrient or a compound of formula (I)

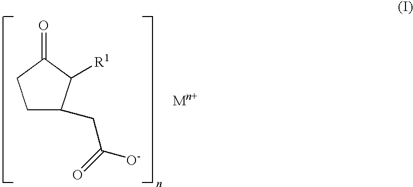

wherein R¹ is a C₁₋₁₀alkyl group, or a C₂₋₁₀alkenyl group and M is a cation of valency n.

According to another aspect of the present invention there is provided the use of a composition or a formulation according to the present invention as a fertilizer for administration to crops.

The invention will now be particularly described by way of the following examples.

### EXAMPLE 1

An agricultural formulation according to the present invention was prepared by admixing the following components.

| Raw Material | % w/w |
|---|---|
| Water | 37.910 |
| Caffeine | 0.020 |
| Sodium Molybdate | 0.015 |
| Boric Acid | 0.600 |
| Phosphoric acid | 33.500 |
| Citric Acid | 5.000 |
| Copper sulphate | 0.450 |
| Manganese sulphate | 1.000 |
| Magnesium sulphate | 6.300 |
| Iron Sulphate | 1.500 |
| Zinc sulphate | 1.450 |
| Cobalt sulphate | 0.050 |
| Nickel sulphate | 0.005 |
| Urea | 11.200 |
| Molasses | 1.000 |

In the formulation of Example 1 caffeine is incorporated with macro- and micro-nutrients into a liquid formulation suitable for foliar spray application. The macronutrient nitrogen is derived from the urea and the macronutrient phosphorous from the phosphoric acid.

### EXAMPLE 2

An agricultural formulation according to the present invention was prepared by admixing the following components.

| Raw Material | % w/w |
|---|---|
| Water | 36.650 |
| Caffeine 99% | 0.020 |
| Calcium Nitrate | 37.500 |
| Boron (derived from Solubor) | 0.830 |
| Urea | 22.000 |
| Citric acid | 1.000 |
| Molasses | 2.000 |

In the formulation of Example 2 caffeine is incorporated with the macronutrient nitrogen and a relatively high dose of the secondary nutrient calcium.

### EXAMPLE 3

An agricultural formulation according to the present invention was prepared by admixing the following components.

| Raw Material | % w/w |
|---|---|
| Water | 53.280 |
| Caffeine 99% | 0.020 |
| Citric acid | 2.000 |
| Potassium Nitrate | 11.000 |
| Potassium Chloride | 3.400 |
| Urea | 29.800 |
| Molasses | 0.500 |

In the formulation of Example 3 caffeine is incorporated with the macronutrients nitrogen and potassium.

### EXAMPLE 4

An agricultural formulation according to the present invention was prepared by admixing the following components.

| | Grade/Element | | |
|---|---|---|---|
| Raw Material | Content | Units | Quantity/1000 Kg |
| Ferrous sulphate | 30% Iron | Kg | 510.000 |
| Anhydrous | | | |
| Magnesium Sulphate | 13.2% Magnesium | Kg | 396.300 |
| Anhydrous | | | |
| Benzoic acid | | Kg | 3.000 |
| Anticake agent | | Kg | 1.000 |
| Calcium Lignosulphate | | Kg | 74.300 |
| Citric acid | | Kg | 10.000 |
| Caffeine | 99% | Kg | 0.200 |
| Dihydrojasmonic acid | Specially | Kg | 0.200 |
| Magnesium salt | manufactured | | |
| L-Arginine | 99% | Kg | 5.000 |

Analysis (Guaranteed Minimum): Iron 15%

### EXAMPLE 5

An agricultural formulation according to the present invention was prepared by admixing the following components.

| | Grade/Element | | |
|---|---|---|---|
| Raw Material | Content | Units | Quantity/1000 Kg |
| Ferrous sulphate | 30% Iron | Kg | 170.000 |
| Anhydrous | | | |
| Zinc sulphate Anhydrous | 36% Zinc | Kg | 170.000 |
| Manganese sulphate | 31% Manganese | Kg | 135.000 |
| Magnesium sulphate | 13.2% Magnesium | Kg | 235.000 |
| Anhydrous | | | |
| Solubor | 20.5% Boron | Kg | 150.000 |
| Copper sulphate | 24.5% Copper | Kg | 45.000 |
| Anhydrous | | | |
| Sodium Molybdate | 38.9% Molybdenum | Kg | 1.300 |
| Benzoic acid | | Kg | 3.000 |
| Anticake agent | | Kg | 1.000 |
| Calcium Lignosulphate | | Kg | 74.300 |
| Citric acid | | Kg | 10.000 |
| Caffeine | 99% | Kg | 0.200 |
| Dihydrojasmonic acid | Specially | Kg | 0.200 |
| Magnesium salt | manufactured | | |
| L-Arginine | 99% | Kg | 5.000 |

Analysis (Guaranteed Minimum): Iron 5%, Manganese 4%, Magnesium 3%,
Copper 1%, Boron 3%, Molybdenum 0.05%, Zinc 6%

### EXAMPLE 6

An agricultural formulation according to the present invention was prepared by admixing the following components.

| | Grade/Element | | |
|---|---|---|---|
| Raw Material | Content | Units | Quantity/1000 Kg |
| Manganese Sulphate | 31% Manganese | Kg | 458.000 |
| Zinc Sulphate (Anhydrous) | 36% Zinc | Kg | 450.000 |
| Anticake | | Kg | 1.000 |
| Calcium Ligno Sulphate | | Kg | 72.600 |
| Citric acid | | Kg | 10.000 |
| Benzoic acid | | Kg | 3.000 |
| Caffeine | 99% | Kg | 0.200 |
| Dihydrojasmonic acid | Specially | Kg | 0.200 |
| Magnesium salt | manufactured | | |
| L-Arginine | 99% | Kg | 5.000 |

Analysis (Guaranteed Minimum): Zn 16%, Mn 14% w/w

The effect of the present invention on the health and yield of plants was evaluated as follows.

Test Trial 1

Sugar Beet Study

Method:

A trial was set up to evaluate what (if any) difference the application of a formulation based on the present invention made to the growth of sugar beet.

Two formulations were used: Formulation 1(Inventive) and the same formulation without caffeine incorporated (Control). The formulations are shown below:

Formulation 1 (Inventive)

Quantity per 1000 kg batch

| Water | mains water | 251.80 kg |
|---|---|---|
| Caffeine | 99% | 0.200 |
| Monoethanolamine | 90% solution | 225.000 |
| Boric acid | 17.4% B | 523.000 |

Control

Quantity per 100 kg batch

| Water | mains water | 252.00 kg |
|---|---|---|
| Monoethanolamine | 90% solution | 225.000 |
| Boric acid | 17.4% B | 523.000 |

The formulations were applied to sugar beet plants located in the test plots (11.1 m² plots×4). The plant variety tested was Nozomi. The plants were transplanted in April, sprayed in July and August and harvested in October.

Results:

| | Inventive | Control |
|---|---|---|
| Yield t/ha | 63.1 | 63.4 |
| Root Sugar % | 15.95 | 15.79 |
| Correct sugar % | 14.11 | 13.93 |
| Sugar yield t/ha | 10.07 | 8.84 |
| K meq/100 g | 3.25 | 3.40 |
| Na meq/100 g | 0.77 | 0.68 |
| Amino N meq/100 g | 1.84 | 1.79 |
| Impurities | 3.99 | 4.04 |

Conclusion:

An increase of root sugar content was observed in the plants to which the Inventive formulation had been applied.

Test Trial 2

Onion Study

Method:

A trial was set up to evaluate what (if any) difference the application of a formulation based on the present invention made to the growth of onions.

Two formulations were used: Formulation l(Inventive) and the same formulation without caffeine incorporated (Control). The formulations are shown below:

Formula 1

| Material | % w/w |
|---|---|
| Water | 24.903 |
| Monoethanolamine (MEA) | 22.500 |
| Boric acid | 52.300 |
| Sodium molybdenate | 00.297 |

Formula 2

| Material | % w/w |
|---|---|
| Water | 24.883 |
| Caffeine | 00.020 |
| Monoethanolamine (MEA) | 22.500 |
| Boric acid | 52.300 |
| Sodium molybdenate | 00.297 |

The formulations were applied to onion plants located in the test plots in Saudi Arabia. One central pivot field was selected and divided into two equal halves. One half was used as the control and the other half was treated with 4 litres of Inventive Formulation three weeks before harvest.

Results:

The yield of onion crop from each plot was determined.

Control: 5803 bags*11 kg/bag/ha=63.83 Mt/ha

Treated: 6885 bags*11 kg/bag/ha=75.73 Mt/ha

The difference in yield between the Control and Treated plots was 75.73−63.83=11.9/63.83*100%=18.6% increase.

Conclusion:

An increase in crop yield was observed in the plants to which the Inventive formulation had been applied.

Test Trial 3

Colour Study

Method:

A trial was set up to evaluate what (if any) difference the application of a formulation based on the present invention made to the maturity of crops when compared to a standard fertiliser product.

Two formulations were used: Formulation 1 (Control) and the same formulation with caffeine incorporated (Inventive). The formulations are shown below:

Formula 1

| Material | % w/w |
|---|---|
| Water | 24.903 |
| Monoethanolamine (MEA) | 22.500 |
| Boric acid | 52.300 |
| Sodium molybdenate | 00.297 |

Formula 2

| Material | % w/w |
|---|---|
| Water | 24.883 |
| Caffeine | 00.020 |
| Monoethanolamine (MEA) | 22.500 |
| Boric acid | 52.300 |
| Sodium molybdenate | 00.297 |

Trial A—Bell Pepper, Jordan Valley

Each treatment was applied to a row of protected Bell Peppers (in a poly-tunnel) as a foliar spray (3 ml/L spray solution, sprayed to runoff). The crop was assessed for colour using a visual score before application, and again after 2 days.

Results:

TABLE 1
Colour change after treatments

Colour score (mean of 10 plants)*

| | 0 DAT | 2DAT |
|---|---|---|
| Treatment 1 | 0.5 | 2 |
| Treatment 2 | 0.5 | 7.5 |

•0 = 100% green; 5 = 50% yellow; 10 = 100% yellow

Discussion

There was a significant difference between the effect of the two treatments on colour of pepper. Treatment 2 showed a significantly higher colour score, indicating that the incorporation of 200 ppm caffeine significantly enhanced maturity of colour in pepper.

Trial B—Tomato, Jordan Valley

Each treatment was applied to 5 mature tomato plants as a foliar spray (3 ml/L spray solution, sprayed to runoff). The fruit was assessed for colour using a visual score before application, and again after 2 days.

Results:

TABLE 1
Colour change after treatments

Colour score (mean of 5 plants)*

| | 0 DAT | 2DAT |
|---|---|---|
| Treatment 1 | 0.0 | 0.0 |
| Treatment 2 | 0.0 | 2.5 |

*0 = 100% green; 5 = 50% red; 10 = 100% red

Discussion

There was a significant difference between the effect of the two treatments on colour of tomato. Treatment 2 showed a significantly higher colour score, indicating that the incorporation of caffeine (200 ppm) significantly enhanced maturity of colour in tomato.

1-4. (canceled)

5. An agricultural composition for use as a plant reproductive growth stimulator, which composition comprises a member of the caffeine family, wherein the caffeine family member is present at a concentration in the range of 50 to 500 ppm.

6. An agricultural composition comprising a member of the caffeine family and a plant health or growth promoter which is a water soluble salt of formula (I) 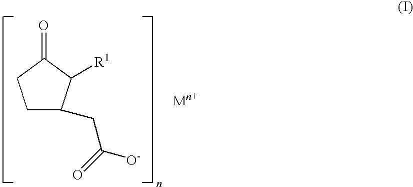
wherein R¹ is a C₁₋₁₀alkyl group, or a C₂₋₁₀alkenyl group and
M is a cation of valency n.

7. An agricultural composition according to claim 6, wherein the caffeine family member is present at a concentration in the range of 50 to 500 ppm.

8. An agricultural composition comprising: (i) a member of the caffeine family and (ii) a plant nutrient, wherein the caffeine family member is present at a concentration in the range of 50 to 500 ppm.

9. A composition according to claim 8, wherein the plant nutrient is one or more macronutrient selected from nitrogen, phosphorus, potassium, carbon and water; one or more secondary nutrient selected from calcium, magnesium, sodium, chloride and sulphur; or one or more micronutrient selected from copper, cobalt, iron, manganese, boron, molybdenum, zinc, silicon and nickel.

10. A composition according to claim 5 or claim 8, wherein the caffeine family member is an unsubstituted, mono-, di- or tri-substituted 2,6 dione derivative of purine.

11. A composition according to claim 5 or claim 8, wherein the caffeine family member is caffeine (3,7-Dihydro-1,3,7-trimethyl-1H-purine-2,6-dione), xanthine (3,7-Dihydro-1H-purine-2,6-dione), theobromine (3,7-Dihydro-3,7-dimethyl-1H-purine-2,6-dione) or theophylline(3,7-Dihydro-1,3-dimethyl-1H-purine-2,6-dione).

12. A formulation for administration to plants or to the environment of plants, the formulation comprising a composition according to claim 5 or claim 8 and a medium in which the composition may be dispersed or dissolved.

13. A method for the preparation of a liquid agricultural formulation comprising a member of the caffeine family, one or more plant nutrient and a solvent, which method comprises admixing the caffeine family member and solvent prior to the addition of the one or more plant nutrient.

14. A method for stimulating reproductive growth in plants, promoting maturity in plants, increasing flowering, accelerating the onset of flowering in plants, accelerating the onset of coloration in plants, or accelerating the onset of fruiting in plants, which method comprises applying a member of the caffeine family to the plants or to the environment thereof.

15-18. (canceled)

19. A method according to claim 14, wherein in addition to the application of a member of the caffeine family the method also comprises applying to the plants or to the environment thereof, simultaneously or successively in either order a plant nutrient or a compound of formula (I) 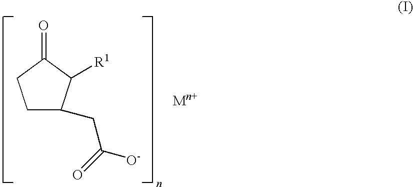
wherein R¹ is a C₁₋₁₀alkyl group, or a C₂₋₁₀alkenyl group and
M is a cation of valency n.

20. (canceled)

21. A method according to claim 19, wherein the plant nutrient is one or more macronutrient selected from nitrogen, phosphorus, potassium, carbon and water; one or more secondary nutrient selected from calcium, magnesium, sodium, chloride and sulphur; or one or more micronutrient selected from copper, cobalt, iron, manganese, boron, molybdenum, zinc, silicon and nickel.

22. A method according to claim 14, wherein the member of the caffeine family is an unsubstituted, mono-, di- or tri-substituted 2,6 dione derivative of purine.

23. A method according to claims 14, wherein the member of the caffeine family is caffeine (3,7-Dihydro-1,3,7-trimethyl-1H-purine-2,6-dione), xanthine (3,7-Dihydro-1H-purine-2,6-dione), theobromine (3,7-Dihydro-3,7-dimethyl-1H-purine-2,6-dione) or theophylline(3,7-Dihydro-1,3-dimethyl-1H-purine-2,6-dione).
